(19) United States
(12) Patent Application Publication
(10) Pub. No.: US 2025/0206017 A1
(43) Pub. Date: Jun. 26, 2025

(54) LIQUID JET HEAD AND LIQUID JET RECORDING APPARATUS

(71) Applicant: SII Printek Inc., Chiba-shi (JP)

(72) Inventor: Takayuki SHIMIZU, Chiba-shi (JP)

(21) Appl. No.: 18/985,541

(22) Filed: Dec. 18, 2024

(30) Foreign Application Priority Data
Dec. 25, 2023 (JP) 2023-218296

(51) Int. Cl. B41J 2/045; B41J 2/18

(52) U.S. Cl. CPC B41J 2/04588; B41J 2/04515; B41J 2/04581; B41J 2/04591; B41J 2/04596; B41J 2/18

(57) ABSTRACT

A liquid jet head and so on capable of easily improving ejection stability of a liquid are provided. A liquid jet head according to an embodiment of the present disclosure includes a jet unit including a plurality of nozzles configured to jet a liquid, and a plurality of pressure chambers communicated individually with the nozzles, and each filled with the liquid, and a drive unit configured to drive the jet unit based on a drive signal having a plurality of pulses in a predetermined print period to thereby jet the liquid which fills an inside of the pressure chamber from the nozzle. The plurality of pulses in the drive signal includes one ejection pulse or a plurality of ejection pulses having a pulse width in a range in which the liquid is ejected from the nozzle, and one heat generation pulse or a plurality of heat generation pulses which has a pulse width in a range in which the liquid is not ejected from the nozzle, and which is configured to control a heat generation amount generated when the jet unit is driven.

### FIELD OF THE INVENTION

### Related Applications

This application claims priority to Japanese Patent application No. JP2023-218296, filed on Dec. 25, 2023, the entire content of which is incorporated herein by reference.

### BACKGROUND OF THE INVENTION

### 1. Field of the Invention

The present disclosure relates to a liquid jet head and a liquid jet recording apparatus.

### 2. Description of the Related Art

Liquid jet recording apparatuses equipped with liquid jet heads are used in a variety of fields, and a variety of types of liquid jet heads have been developed (see, e.g., JP2012-214018A).

In such a liquid jet head, in general, it is required to easily improve ejection stability of a liquid. It is desirable to provide a liquid jet head and a liquid jet recording apparatus capable of easily improving the ejection stability of the liquid.

### SUMMARY OF THE INVENTION

A liquid jet head according to an embodiment of the present disclosure includes a jet unit including a plurality of nozzles configured to jet a liquid, and a plurality of pressure chambers communicated individually with the nozzles, and each filled with the liquid, and a drive unit configured to drive the jet unit based on a drive signal having a plurality of pulses in a predetermined print period to thereby jet the liquid which fills an inside of the pressure chamber from the nozzle.

The plurality of pulses in the drive signal includes one ejection pulse or a plurality of ejection pulses having a pulse width in a range in which the liquid is ejected from the nozzle, and one heat generation pulse or a plurality of heat generation pulses which has a pulse width in a range in which the liquid is not ejected from the nozzle, and which is configured to control a heat generation amount generated when the jet unit is driven.

The liquid jet recording apparatus according to an embodiment of the present disclosure is equipped with the liquid jet head according to an embodiment of the present disclosure described above.

According to the liquid jet head and the liquid jet recording apparatus related to an embodiment of the present disclosure, it becomes possible to easily improve the ejection stability of the liquid.

### BRIEF DESCRIPTION OF THE DRAWINGS

FIG. 1 is a schematic perspective view showing a schematic configuration example of a liquid jet recording apparatus according to an embodiment of the present disclosure.

FIG. 2 is a schematic diagram showing a schematic configuration example of a liquid jet head shown in FIG. 1.

FIG. 3 is an exploded perspective view showing a detailed configuration example of the liquid jet head shown in FIG. 1.

FIG. 4 is a schematic diagram showing a planar configuration example of an actuator plate and so on shown in FIG. 3.

FIG. 5 is a schematic diagram showing a cross-sectional configuration example along the line V-V shown in FIG. 4.

FIG. 6 is a schematic diagram showing a cross-sectional configuration example along the line VI-VI shown in FIG. 4.

FIG. 7 is a schematic cross-sectional view showing, in an enlarged manner, the part VII shown in FIG. 5.

FIG. 8 is a schematic diagram showing a supply channel example of electrical potentials to be supplied from a drive unit to drive electrodes.

FIG. 9 is a timing chart schematically showing a waveform example of a drive signal.

FIGS. 10A, 10B, 10C and 10D are timing charts schematically showing a variety of waveform examples in the drive signal.

FIG. 11 is a diagram showing an example of a correspondence relationship between a drive frequency and an ejection speed corresponding to the viscosity of a liquid in a general liquid jet head.

FIG. 12 is a diagram showing an example of a result of an importance analysis of a variety of parameters making a contribution to the temperature of a jet unit.

FIGS. 13A, 13B and 13C are timing charts schematically showing an example of a variety of pulses in a drive signal related to Comparative Examples 1, 2 and Practical Example 1.

FIG. 14 is a diagram showing an example of average ejection speeds in a variety of conditions related to Comparative Examples 1, 2 and Practical Example 1.

FIG. 15 is a diagram showing another example of the average ejection speeds in a variety of conditions related to Comparative Examples 1, 2 and Practical Example 1.

FIG. 16 is a timing chart schematically showing an example of a variety of pulses in a drive signal related to Practical Example 2.

FIG. 17 is a plan view schematically showing an example of temperature measurement places in a common flow channel shown in FIG. 3 and so on.

FIG. 18 is a diagram showing an example of temporal changes in temperature in the respective temperature measurement places shown in FIG. 17.

FIG. 19 is a schematic plan view illustrating a method example of a heat generation amount adjustment according to Practical Example 3.

### DETAILED DESCRIPTION OF THE PREFERRED EMBODIMENTS

An embodiment of the present disclosure will hereinafter be described in detail with reference to the drawings. It should be noted that the description will be presented in the following order.

1. Embodiment (an example when the present disclosure is applied to a circulation type liquid jet head)

### 2. Modified Examples

### 1. Embodiment

### [A. Overall Configuration of Printer 1]

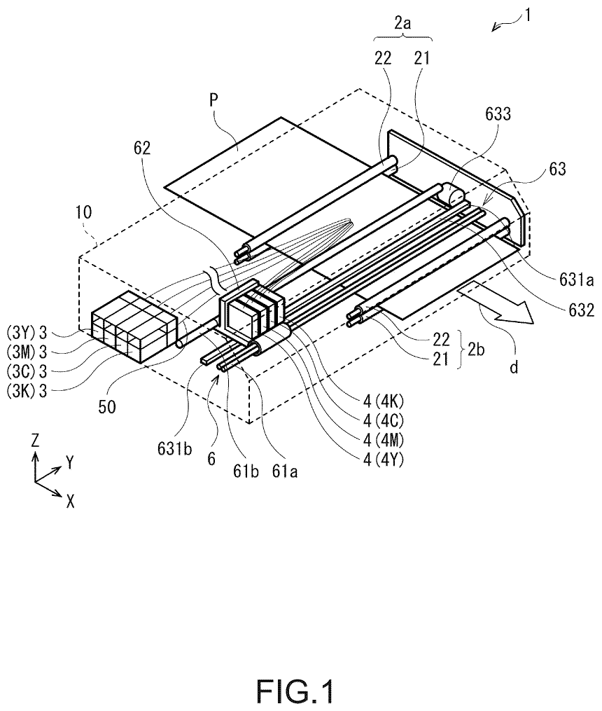

FIG. 1 is a perspective view schematically showing a schematic configuration example of a printer 1 as a liquid jet recording apparatus according to an embodiment of the present disclosure. The printer 1 is an inkjet printer for performing recording (printing) of images, characters, and the like on recording paper P as a recording target medium using ink 9 described later. It should be noted that the recording target medium is not limited to paper, but includes a material on which recording can be performed such as ceramic or glass.

As shown in FIG. 1, the printer 1 is provided with a pair of conveying mechanisms 2a, 2b, ink tanks 3, inkjet heads 4, ink supply tubes 50, and a scanning mechanism 6. These members are housed in a chassis 10 having a predetermined shape. In the present embodiment, the description will be presented citing a circulation type inkjet head using the ink 9 by circulating the ink 9 between the ink tanks 3 and the inkjet heads 4 as an example although described later in detail.

It should be noted that a scale size of each of the members is accordingly altered so that the member is shown in a recognizable size in the drawings used in the description of the present specification.

Here, the printer 1 corresponds to a specific example of a “liquid jet recording apparatus” in the present disclosure, and the inkjet heads 4 (inkjet heads 4Y, 4M, 4C, and 4K described later) each correspond to a specific example of a “liquid jet head” in the present disclosure. Further, the ink 9 corresponds to a specific example of a “liquid” in the present disclosure. It should be noted that the “liquid” in the present disclosure is not limited to the ink 9 (“typical ink for forming images”) described in the present embodiment.

As shown in FIG. 1, the conveying mechanisms 2a, 2b are each a mechanism for conveying the recording paper P along a conveyance direction d (an X-axis direction). These conveying mechanisms 2a, 2b each have a grit roller 21, a pinch roller 22, and a drive mechanism (not shown). This drive mechanism is a mechanism for rotating (rotating in a Z-X plane) the grit roller 21 around an axis, and is constituted by, for example, a motor.

### (Ink Tanks 3)

The ink tanks 3 are tanks for containing the ink 9 inside. As the ink tanks 3, there are disposed four types of tanks which individually contain the ink 9 of four colors of yellow (Y), magenta (M), cyan (C), and black (K) in this example as shown in FIG. 1. Specifically, there are disposed an ink tank 3Y for containing the ink 9 having a yellow color, an ink tank 3M for containing the ink 9 having a magenta color, an ink tank 3C for containing the ink 9 having a cyan color, and an ink tank 3K for containing the ink 9 having a black color. These ink tanks 3Y, 3M, 3C, and 3K are arranged side by side along the X-axis direction inside the chassis 10.

It should be noted that the ink tanks 3Y, 3M, 3C, and 3K have the same configuration except the color of the ink 9 contained therein, and are therefore collectively referred to as the ink tanks 3 in the following description.

### (Inkjet Heads 4)

The inkjet heads 4 are each a head for jetting (ejecting) the ink 9 shaped like a droplet from a plurality of nozzles (nozzle holes Hn) described later to the recording paper P to thereby perform recording (printing) of images, characters, and so on. As the inkjet heads 4, there are also provided four types of heads for individually jetting the four colors of ink 9 respectively contained in the ink tanks 3Y, 3M, 3C, and 3K described above in this example as shown in FIG. 1. Specifically, there are disposed the inkjet head 4Y for jetting the ink 9 having the yellow color, the inkjet head 4M for jetting the ink 9 having the magenta color, the inkjet head 4C for jetting the ink 9 having the cyan color, and the inkjet head 4K for jetting the ink 9 having the black color. These inkjet heads 4Y, 4M, 4C and 4K are arranged side by side along the Y-axis direction inside the chassis 10.

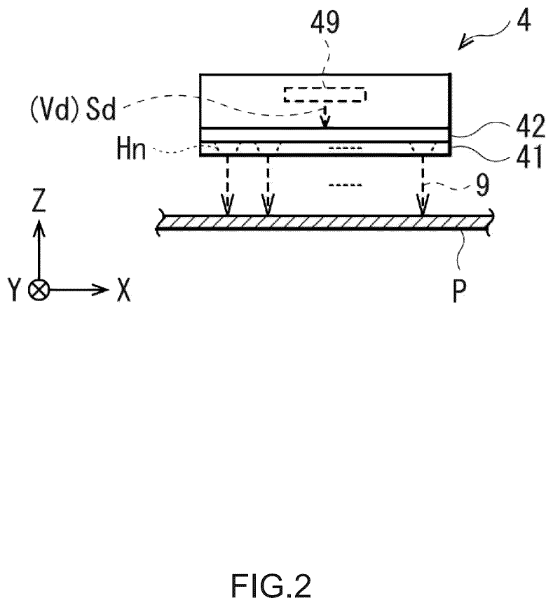

It should be noted that the inkjet heads 4Y, 4M, 4C and 4K have the same configuration except the color of the ink 9 used therein, and are therefore collectively referred to as the inkjet heads 4 in the following description. Further, the detailed configuration example of the inkjet heads 4 will be described later (FIG. 2 to FIG. 7).

The ink supply tubes 50 are each a tube through which the ink 9 is supplied from the inside of the ink tank 3 toward the inside of the inkjet head 4. The ink supply tubes 50 are each formed of, for example, a flexible hose having such flexibility as to be able to follow the action of the scanning mechanism 6 described below.

### (Scanning Mechanism 6)

The scanning mechanism 6 is a mechanism for making the inkjet heads 4 perform a scanning operation along the width direction of the recording paper P (the Y-axis direction). As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction.

The drive mechanism 63 has a pair of pulleys 631a, 631b disposed between the guide rails 61a, 61b, an endless belt 632 wound between these pulleys 631a, 631b, and a drive motor 633 for rotationally driving the pulley 631a. Further, on the carriage 62, there are arranged the four types of inkjet heads 4Y, 4M, 4C and 4K described above side by side along the Y-axis direction.

It should be noted that it is arranged that such a scanning mechanism 6 and the conveying mechanisms 2a, 2b described above constitute a moving mechanism for moving the inkjet heads 4 and the recording paper P relatively to each other. It should be noted that the moving mechanism of such a method is not a limitation, and it is also possible to adopt, for example, a method (a so-called “single-pass method”) of moving only the recording target medium (the recording paper P) while fixing the inkjet heads 4 to thereby move the inkjet heads 4 and the recording target medium relatively to each other.

### [B. Detailed Configuration of Inkjet Heads 4]

Then, a detailed configuration example of the inkjet head 4 will be described with reference to FIG. 2 to FIG. 7.

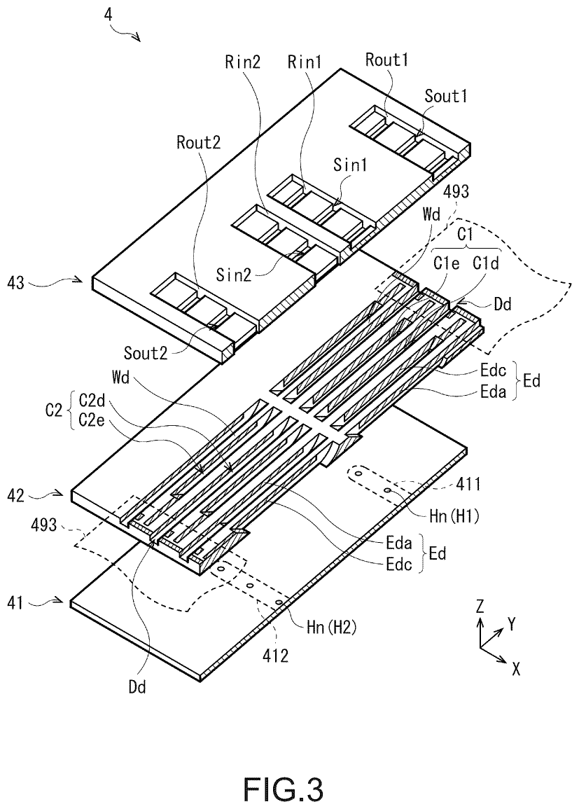

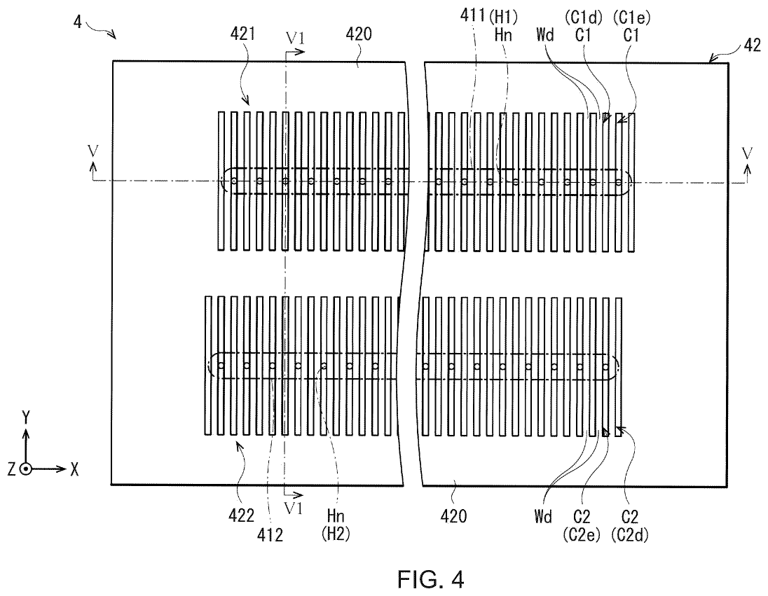

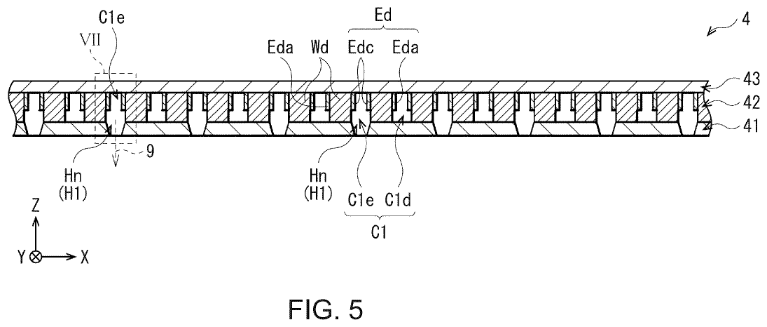

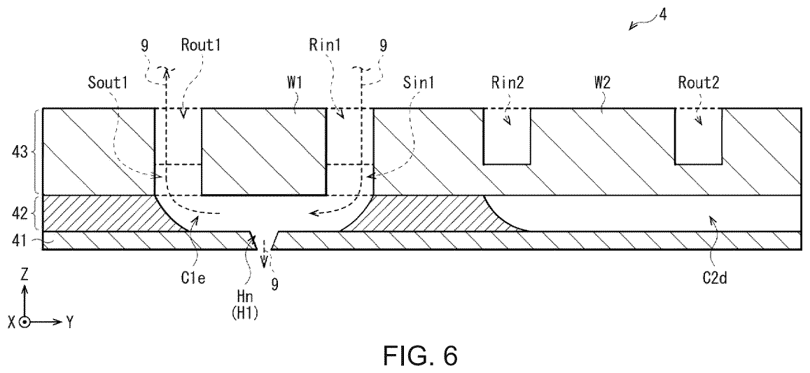

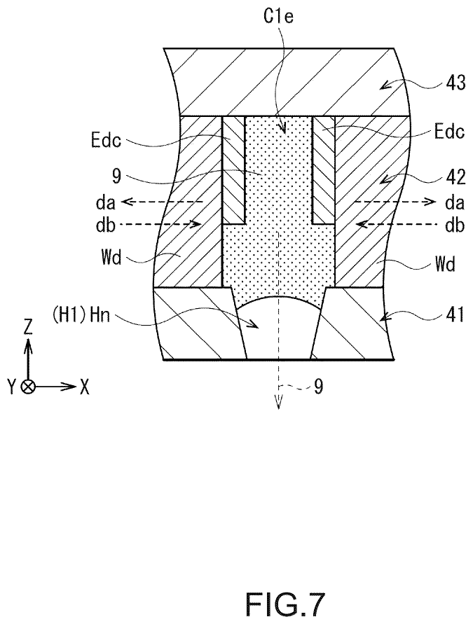

FIG. 2 is a diagram schematically showing a schematic configuration example of each of the inkjet heads 4. It should be noted that in FIG. 2, a cover plate 43 described later is omitted from the illustration for the sake of convenience. FIG. 3 is an exploded perspective view showing a detailed configuration example of the inkjet head 4 shown in FIG. 1. FIG. 4 schematically shows a planar configuration example (a configuration example in the X-Y plane) of an actuator plate 42 and so on shown in FIG. 3. It should be noted that in FIG. 4 described above, the actuator plate 42 of the inkjet head 4 is selectively shown for the sake of convenience. FIG. 5 is a diagram schematically showing a cross-sectional configuration example (a configuration example in a Z-X cross-sectional surface) along the line V-V shown in FIG. 4, and FIG. 6 is a diagram schematically showing a cross-sectional configuration example (a configuration example in a Z-Y cross-sectional surface) along the line VI-VI shown in FIG. 4. FIG. 7 is a cross-sectional view (a Z-X cross-sectional view) schematically showing, in an enlarged manner, the part VII shown in FIG. 5.

The inkjet heads 4 according to the present embodiment are each an inkjet head of a so-called side-shoot type for ejecting the ink 9 from a central portion in the extending direction (the Y-axis direction) in each of a plurality of channels (channels C1, C2) described later. Further, as shown in FIG. 2 to FIG. 7, this inkjet head 4 has a nozzle plate 41, the actuator plate 42, the cover plate 43, and a drive unit 49.

It should be noted that the nozzle plate 41, the actuator plate 42, and the cover plate 43 correspond to a specific example of a “jet unit” in the present disclosure.

The nozzle plate 41, the actuator plate 42, and the cover plate 43 described above are bonded to each other using, for example, an adhesive, and are stacked on one another in this order along the Z-axis direction. Further, it is also possible to arrange that a flow channel plate (not shown) having predetermined flow channels is disposed on an upper surface of the cover plate 43. It should be noted that the description will hereinafter be presented referring to a cover plate 43 side along the Z-axis direction as an upper side, and referring to a nozzle plate 41 side as a lower side, as appropriate.

### (B-1. Nozzle Plate 41)

The nozzle plate 41 is a plate formed of a film material such as polyimide, or a metal material, and has the plurality of nozzle holes Hn (H1, H2) for jetting the ink 9 (see FIG. 2 to FIG. 7). These nozzle holes Hn are formed side by side in alignment (along the X-axis direction in this example) at predetermined intervals. Further, as shown in FIG. 3 and FIG. 4, the nozzle plate 41 is provided with two nozzle arrays (nozzle arrays 411, 412) each extending along the X-axis direction. These nozzle arrays 411, 412 are arranged along the Y-axis direction at a predetermined distance. As described above, the inkjet heads 4 are each formed as a two-column type inkjet head.

The nozzle array 411 has the plurality of nozzle holes H1 formed in alignment side by side at predetermined intervals along the X-axis direction. These nozzle holes H1 each penetrate the nozzle plate 41 along the thickness direction (the Z-axis direction) of the nozzle plate 41, and are communicated with respective ejection channels Cle in the actuator plate 42 described later. Specifically, as shown in FIG. 4, each of the nozzle holes H1 is formed so as to be located in a central portion along the Y-axis direction on the ejection channel Cle. Further, the formation pitch along the X-axis direction in the nozzle holes H1 is arranged to be the same (the same pitch) as the formation pitch along the X-axis direction in the ejection channels Cle. Although the details will be described later, it is arranged that the ink 9 supplied from the inside of the ejection channel Cle is ejected (jetted) from each of the nozzle holes H1 in such a nozzle array 411.

The nozzle array 412 similarly has the plurality of nozzle holes H2 formed in alignment side by side at predetermined intervals along the X-axis direction. Each of these nozzle holes H2 also penetrates the nozzle plate 41 along the thickness direction of the nozzle plate 41, and is communicated with an ejection channel C2e in the actuator plate 42 described later. Specifically, as shown in FIG. 4, each of the nozzle holes H2 is formed so as to be located in a central portion along the Y-axis direction on the ejection channel C2e. Further, the formation pitch along the X-axis direction in the nozzle holes H2 is arranged to be the same as the formation pitch along the X-axis direction in the ejection channels C2e. Although the details will be described later, it is arranged that the ink 9 supplied from the inside of the ejection channel C2e is also ejected from each of the nozzle holes H2 in such a nozzle array 412.

It should be noted that such nozzle holes Hn (H1, H2) are each formed as a tapered through hole gradually decreasing in diameter in a direction toward the lower side (see FIG. 2, and FIG. 5 to FIG. 7), and each correspond to a specific example of a “nozzle” in the present disclosure.

### (B-2. Actuator Plate 42)

The actuator plate 42 is a plate formed of a piezoelectric material such as lead zirconium titanate (PZT), and is arranged to change the volume of each of the ejection channels Cle, C2e described later although the details will be described later. The actuator plate 42 is formed of, for example, a single (unique) piezoelectric substrate having the polarization direction set to one direction along the thickness direction (the Z-axis direction) (a so-called cantilever type). However, the configuration of the actuator plate 42 is not limited to the cantilever type described above. That is, for example, it is possible to arrange that the actuator plate 42 is formed by stacking two piezoelectric substrates different in polarization direction from each other on one another along the thickness direction (the Z-axis direction) (a so-called chevron type).

Further, as shown in FIG. 3 and FIG. 4, the actuator plate 42 is provided with two channel columns (channel columns 421, 422) each extending along the X-axis direction. These channel columns 421, 422 are arranged at a predetermined distance along the Y-axis direction.

In such an actuator plate 42, as shown in FIG. 4, a central portion (the formation area of the channel columns 421, 422) along the X-axis direction forms an ejection area (jetting area) of the ink 9. On the other hand, in the actuator plate 42, the both end portions (non-formation areas of the channel columns 421, 422) along the X-axis direction each correspond to a non-ejection area (non-jetting area) of the ink 9. The non-ejection areas are each located at the outer side along the X-axis direction with respect to the ejection area described above. It should be noted that both end portions along the Y-axis direction in the actuator plate 42 each form a tail part 420 (see FIG. 4).

As shown in FIG. 3 and FIG. 4, the channel column 421 described above has the plurality of channels C1 each extending along the Y-axis direction. These channels C1 are arranged side by side so as to be parallel to each other at predetermined intervals along the X-axis direction. As shown in FIG. 3, FIG. 5, and FIG. 7, each of the channels C1 is partitioned with drive walls Wd formed of a piezoelectric body (the actuator plate 42), and forms a groove part having a recessed shape in a cross-sectional view.

As shown in FIG. 3 and FIG. 4, the channel column 422 similarly has the plurality of channels C2 each extending along the Y-axis direction. These channels C2 are arranged side by side so as to be parallel to each other at predetermined intervals along the X-axis direction. As shown in FIG. 3, each of the channels C2 is also partitioned by the drive walls Wd described above, and forms a groove part having a recessed shape in a cross-sectional view. It should be noted that although described later in detail, each of the drive walls Wd is arranged to function as an element (a piezoelectric element) for individually pressurizing the inside of each of the channels C1, C2 (each of the ejection channels Cle, C2e described later).

Here, as shown in FIG. 3 to FIG. 5, as the channels C1, there exist the ejection channels Cle for ejecting the ink 9 (filled with the ink 9), and dummy channels C1d not ejecting the ink 9 (not filled with the ink 9). In the channel column 421, these ejection channels Cle and these dummy channels C1d are alternately arranged along the X-axis direction via the drive walls Wd described above. The ejection channels Cle are individually communicated with the nozzle holes H1 in the nozzle plate 41 on the one hand, but the dummy channels Cd are not communicated with these nozzle holes H1, and are covered with the upper surface of the nozzle plate 41 from below on the other hand (see FIG. 5).

Similarly, as shown in FIG. 3 and FIG. 4, as the channels C2, there exist the ejection channels C2e for ejecting the ink 9 (filled with the ink 9), and dummy channels C2d not ejecting the ink 9 (not filled with the ink 9). In the channel column 422, these ejection channels C2e and these dummy channels C2d are alternately arranged along the X-axis direction via the drive walls Wd described above. The ejection channels C2e are individually communicated with the nozzle holes H2 in the nozzle plate 41 on the one hand, but the dummy channels C2d are not communicated with these nozzle holes H2, and are covered with the upper surface of the nozzle plate 41 from below on the other hand.

It should be noted that such ejection channels Cle, C2e each correspond to a specific example of the “pressure chamber” in the present disclosure.

As shown in FIG. 3 and FIG. 4, the ejection channels Cle and the dummy channels C1d as the channels C1 and the ejection channels C2e and the dummy channels C2d as the channels C2 are arranged in a staggered manner. Therefore, in each of the inkjet heads 4, the ejection channels C1e in the channels C1 and the ejection channels C2e in the channels C2 are arranged in a zigzag manner. It should be noted that as shown in FIG. 3, in the actuator plate 42, in a portion corresponding to each of the dummy channels C1d, C2d, there is formed a shallow groove part Dd communicated with an outside end portion extending along the Y-axis direction in the dummy channel C1d, C2d.

Further, as shown in FIG. 3 and FIG. 6, the ejection channels C1e each have side surfaces each shaped like a circular arc in which the cross-sectional area of each of the ejection channels C1e gradually decreases in a direction from the cover plate 43 side (upper side) toward the nozzle plate 41 side (lower side). Similarly, as shown in FIG. 3, the ejection channels C2e each have side surfaces each shaped like a circular arc in which the cross-sectional area of each of the ejection channels C2e gradually decreases in the direction from the cover plate 43 side toward the nozzle plate 41 side. It should be noted that it is arranged that the side surfaces shaped like a circular arc in such ejection channels C1e, C2e are each formed by, for example, cutting work using a dicer.

Here, as shown in FIG. 3, FIG. 5, and FIG. 7, drive electrodes Ed extending along the Y-axis direction are disposed on the inner side surfaces opposed to each other in the drive walls Wd described above. In other words, a pair of the drive electrodes Ed are arranged so as to be opposed to each other across each of the drive walls Wd. As the drive electrodes Ed, there exist common electrodes Edc disposed on the inner side surfaces facing the ejection channels C1e, C2e, and individual electrodes Eda (active electrodes) disposed on the inner side surfaces facing the dummy channels C1d, C2d. It should be noted that each of such drive electrodes Ed (the common electrodes Edc and the individual electrodes Eda) is not formed beyond an intermediate position in the depth direction (the Z-axis direction) on the inner side surface of the drive wall Wd as shown in FIG. 3, FIG. 5, and FIG. 7.

The pair of common electrodes Edc opposed to each other in the same ejection channel C1e (or the same ejection channel C2e) are electrically coupled to each other in a common terminal (not shown). Further, the pair of individual electrodes Eda opposed to each other in the same dummy channel C1d (or the same dummy channel C2d) are electrically separated from each other. Meanwhile, the pair of individual electrodes Eda opposed to each other via the ejection channel C1e (or the ejection channel C2e) are electrically coupled to each other in an individual terminal (not shown).

Here, in the tail part 420 described above, there is mounted a flexible printed board 493 for electrically coupling the drive electrodes Ed and the drive unit 49 as shown in FIG. 3. Wiring patterns (not shown) provided to the flexible printed board 493 are electrically coupled to the common terminals and the individual terminals described above. Thus, it is arranged that a drive voltage Vd (a drive signal Sd) or the like described later is applied to each of the drive electrodes Ed from the drive unit 49 described later via the flexible printed board 493 (see FIG. 2).

### (B-3. Cover Plate 43)

As shown in FIG. 3, and FIG. 5 to FIG. 7, the cover plate 43 is disposed so as to close the channels C1, C2 (the channel columns 421, 422) in the actuator plate 42. Specifically, the cover plate 43 is bonded to the upper surface of the actuator plate 42 to form a plate-like structure.

As shown in FIG. 3 and FIG. 6, the cover plate 43 is provided with a pair of supply-side common flow channels Rin1, Rin2 and a pair of recovery-side common flow channels Rout1, Rout2. Further, as shown in FIG. 6, the cover plate 43 is provided with wall parts W1, W2.

The wall part W1 is disposed so as to cover above the ejection channels C1e and the dummy channels C1d, and the wall part W2 is disposed so as to cover above the ejection channels C2e and the dummy channels C2d (see FIG. 6).

The supply-side common flow channels Rin1, Rin2 and the recovery-side common flow channels Rout1, Rout2 each extend along the X-axis direction, and are arranged side by side so as to be parallel to each other at predetermined intervals along the Y-axis direction as shown in FIG. 3. The supply-side common flow channel Rin1 and the recovery-side common flow channel Rout1 are each formed in an area corresponding to the channel column 421 (the plurality of channels C1) in the actuator plate 42 (see FIG. 3 and FIG. 6). In contrast, the supply-side common flow channel Rin2 and the recovery-side common flow channel Rout2 are each formed in an area corresponding to the channel column 422 (the plurality of channels C2) in the actuator plate 42 (see FIG. 3 and FIG. 6).

The supply-side common flow channel Rin1 is formed in the vicinity of an end portion at an inner side (at one side of the wall part W1) along the Y-axis direction in each of the channels C1, and forms a groove part having a recessed shape (see FIG. 3 and FIG. 6). In areas corresponding respectively to the ejection channels C1e in this supply-side common flow channel Rin1, there are formed supply slits Sin1 penetrating the cover plate 43 along the thickness direction (the Z-axis direction) of the cover plate 43 (see FIG. 3 and FIG. 6). Similarly, the supply-side common flow channel Rin2 is formed in the vicinity of an end portion at an inner side (at one side of the wall part W2) along the Y-axis direction in each of the channels C2, and forms a groove part having a recessed shape (see FIG. 3 and FIG. 6). In areas corresponding respectively to the ejection channels C2e in this supply-side common flow channel Rin2, there are formed supply slits Sin2 penetrating the cover plate 43 along the thickness direction of the cover plate 43 (see FIG. 3).

The recovery-side common flow channel Rout1 is formed in the vicinity of an end portion at an outer side (at the other side of the wall part W1) along the Y-axis direction in each of the channels C1, and forms a groove part having a recessed shape (see FIG. 3 and FIG. 6). In areas corresponding respectively to the ejection channels C1e in the recovery-side common flow channel Rout1, there are formed recovery slits Sout1 penetrating the cover plate 43 along the thickness direction of the cover plate 43 (see FIG. 3 and FIG. 6). Similarly, the recovery-side common flow channel Rout2 is formed in the vicinity of an end portion at an outer side (at the other side of the wall part W2) along the Y-axis direction in each of the channels C2, and forms a groove part having a recessed shape (see FIG. 3 and FIG. 6). In areas corresponding respectively to the ejection channels C2e in the recovery-side common flow channel Rout2, there are formed recovery slits Sout2 penetrating the cover plate 43 along the thickness direction of the cover plate 43 (see FIG. 3).

Here, the supply-side common flow channels Rin1, Rin2 each correspond to a specific example of a “liquid supply flow channel” in the present disclosure. Meanwhile, the recovery-side common flow channels Rout1, Rout2 each correspond to a specific example of a “liquid recovery flow channel” in the present disclosure. Further, these supply-side common flow channels Rin1, Rin2 and these recovery-side common flow channels Rout1, Rout2 each correspond to a specific example of a “common flow channel” in the present disclosure.

In such a manner, it is arranged that the supply-side common flow channel Rin1 and the recovery-side common flow channel Rout1 are communicated with each of the ejection channels C1e via the supply slit Sin1 and the recovery slit Sout1, respectively (see FIG. 3 and FIG. 6). Further, the supply slit Sin1 and the recovery slit Sout1 form through holes through which the ink 9 flows to and from the ejection channel C1e, respectively. Particularly, it is arranged that the supply-side common flow channel Rin1 supplies the ink 9 to the inside of the ejection channel C1e via the supply slit Sin1, and the recovery-side common flow channel Rout1 recovers the ink 9 from the inside of the ejection channel C1e via the recovery slit Sout1 (see the dotted arrow in FIG. 6). In contrast, neither the supply-side common flow channel Rin1 nor the recovery-side common flow channel Rout1 is communicated with the dummy channels C1d. Specifically, each of the dummy channels C1d is arranged to be closed by bottom portions in the supply-side common flow channel Rin1 and the recovery-side common flow channel Rout1.

Similarly, it is arranged that the supply-side common flow channel Rin2 and the recovery-side common flow channel Rout2 are communicated with each of the ejection channels C2e via the supply slit Sin2 and the recovery slit Sout2, respectively (see FIG. 3). Further, the supply slit Sin2 and the recovery slit Sout2 form through holes through which the ink 9 flows to and from the ejection channel C2e, respectively. Particularly, it is arranged that the supply-side common flow channel Rin2 supplies the ink 9 to the inside of the ejection channel C2e via the supply slit Sin2, and the recovery-side common flow channel Rout2 recovers the ink 9 from the inside of the ejection channel C2e via the recovery slit Sout2. In contrast, neither the supply-side common flow channel Rin2 nor the recovery-side common flow channel Rout2 is communicated with the dummy channels C2d (see FIG. 6). Specifically, each of the dummy channels C2d is arranged to be closed by bottom portions in the supply-side common flow channel Rin2 and the recovery-side common flow channel Rout2 (see FIG. 6).

### (B-4. Drive Unit 49)

As shown in FIG. 2, the drive unit 49 is for performing ejection drive of the ink 9 using the drive signal Sd (the drive voltage Vd). On this occasion, the drive unit 49 is arranged to output such a drive signal Sd (such a drive voltage Vd) based on a variety of types of data (signals) supplied from a print control unit (not shown) located inside the printer 1 (inside the inkjet head 4).

Further, the drive unit 49 drives the actuator plate 42 so that the ink 9 filling the ejection channels C1e, C2e described above is ejected from the nozzle holes Hn (H1, H2), to thereby perform the ejection drive (see FIG. 2, and FIG. 5 to FIG. 7). Specifically, the drive unit 49 is arranged to apply the drive voltages Vd (the drive signals Sd) described above to the actuator plate 42 to expand and contract the ejection channels C1e, C2e to thereby jet (make the actuator plate 42 perform the jetting operation) the ink 9 from the respective nozzle holes Hn.

[C. Detailed Configuration of Drive Voltage Vd and Drive signal Sd]

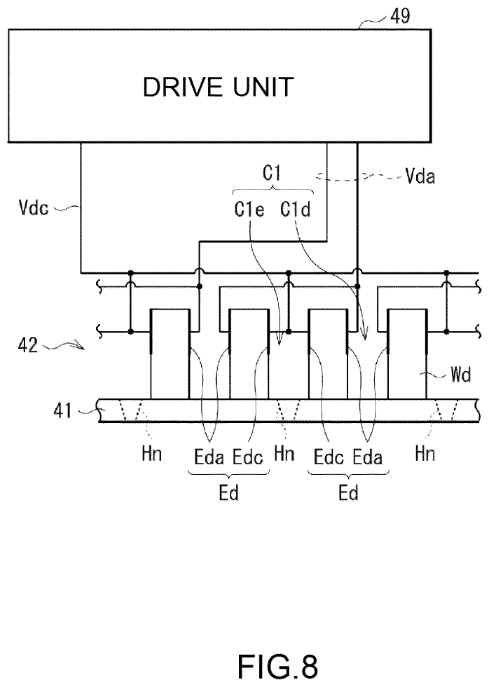

Subsequently, the detailed configuration example of the drive voltage Vd and the drive signal Sd described above will be described with reference to FIG. 8 through FIG. 10.

FIG. 8 is a diagram schematically showing supply channel examples of the electrical potentials supplied from the drive unit 49 to the drive electrodes Ed (the individual electrodes Eda and the common electrodes Edc). Specifically, FIG. 8 shows the supply channel examples related to the channel C1 regarding the electrical potentials (individual potentials Vda) supplied to the individual electrodes Eda and an electrical potential (a common potential Vdc) supplied to the common electrodes Edc, respectively.

It should be noted that although not shown in FIG. 8 for the sake of convenience, the same applies also to the supply channel example (the supply channel example of the individual potentials Vda and the common potential Vdc) related to the channel C2.

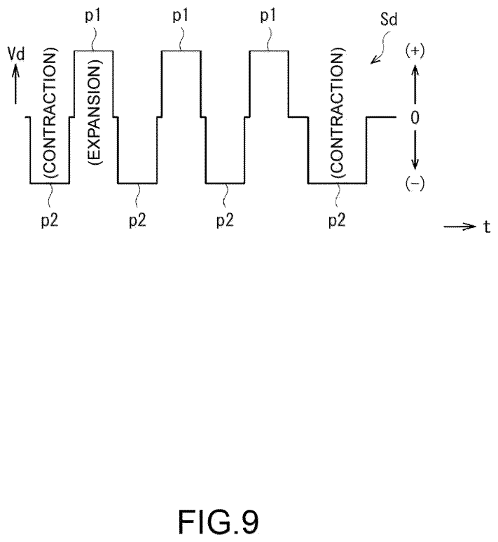

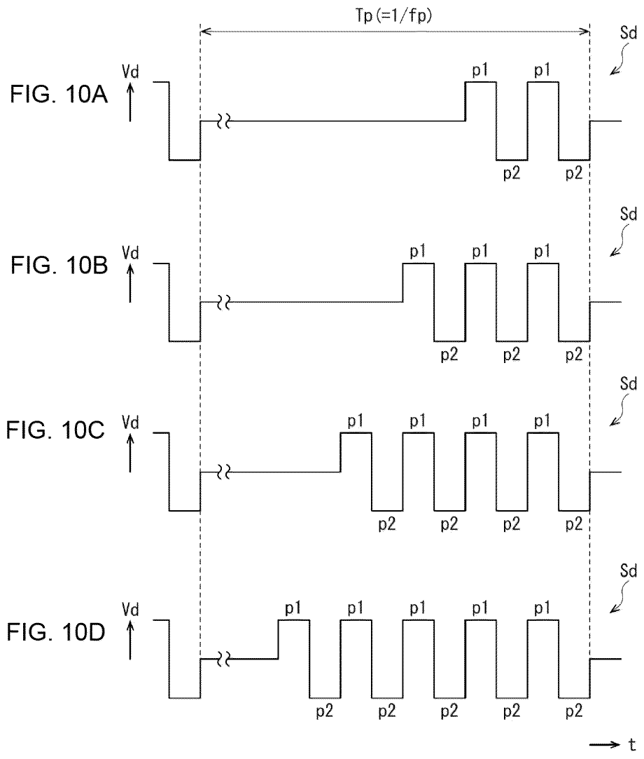

Further, FIG. 9 is a timing chart schematically showing a waveform example of the drive signal Sd. FIGS. 10A to 10D are timing charts schematically showing a variety of waveform examples of the drive signal Sd.

It should be noted that in all of FIG. 9 and FIGS. 10A to 10D, the vertical axis represents a voltage value of the drive voltage Vd (corresponding to a potential difference between the individual potential Vda and the common potential Vdc described above; Vd=Vda−Vdc), and the horizontal axis represents time t. Further, the magnitude of such a drive voltage Vd corresponds to a volume of each of the ejection channels C1e, C2e described above. Further, when the drive voltage Vd has a positive (+) value, and when the drive voltage Vd has a negative (−) value represent a state in which the volume expands compared to a reference value, and a state in which the volume contracts compared to the reference value, respectively (see FIG. 9).

Incidentally, in the example shown in FIG. 9, the common potential Vdc is set to a predetermined positive potential (Vdc>0) to thereby arrange that the drive voltage Vd (the potential difference between the individual potential Vda and the common potential Vdc) is set to a negative value (Vd<0), but this example is not a limitation. Specifically, it is also possible to arrange that the drive voltage Vd is directly set to a negative value (Vd<0) by, for example, setting the common potential Vdc to Vdc=0 (a ground potential), and at the same time, setting the individual potential Vda to a predetermined negative potential (Vda<0). Even in the case of such drive, it is possible to perform substantially the same drive (a pressure variation in the actuator plate 42) as the drive example shown in FIG. 9.

In the examples shown in FIG. 9 and FIGS. 10A to 10D, the drive signal Sd is a signal (a signal to which a so-called “multi-pass method” is applied) having a plurality of pulses (pulses p1, p2) in one cycle (a print period Tp described below). The pulse p1 is a pulse (an expansion pulse) for expanding the volume of the ejection channels C1e, C2e, and the pulse p2 is a pulse (a contraction pulse) for contracting the volume of the ejection channels C1e, C2e. Further, in each of the examples shown in FIGS. 10A to 10D, out of the plurality of pulses in one cycle (the print period Tp), the first pulse is set as the pulse p1, and the last pulse is set as the pulse p2. It should be noted that the first pulse in the print period Tp may be set as either of the pulse p1 (the expansion pulse) and the pulse p2 (the contraction pulse).

The “one cycle (=the print period Tp)” described above means a time interval for forming one pixel (dot) on the recording paper P (the recording target medium). Further, a print frequency fp in the drive signals Sd shown in FIGS. 10A to 10D is set as the reciprocal (fp=1/Tp) of the print period Tp. In other words, the print frequency fp corresponds to the number of pixels (the number of dots) formed per second on the recording paper P (the recording target medium).

Here, in the present embodiment, it is arranged that the following is included as the plurality of pulses in the drive signal Sd described above although the details will be described later. That is, first, the drive signal Sd includes one ejection pulse Pj or a plurality of pulses Pj having a pulse width Wj in a range (level) in which the ink 9 is ejected from the nozzle hole Hn. It should be noted that the ejection pulse Pj corresponds to an aggregate of the pulses p1, p2 described above although the details will be described later. Further, the drive signal Sd includes one heat generation pulse Ph or a plurality of heat generation pulses Ph which has a pulse width Wh (corresponding to pulse widths Wh1, Wh2 described later) in a range (level) in which the ink 9 is not ejected from the nozzle hole Hn, and which controls a heat generation amount Δh generated when performing the drive described above by the drive unit 49.

Incidentally, the pulse width Wh in a range in which the ink 9 is not ejected from the nozzle hole Hn means, for example, a size in a level of ⅙ to ⅓ of a resonance period (AP: Acoustic Period). In other words, as the range of the pulse width Wh, there can be cited, for example, (AP/6)≤Wh≤(AP/3). Meanwhile, as the pulse width Wj in a range in which the ink 9 is ejected from the nozzle hole Hn, there can be cited, for example, a range larger than the pulse width Wh described above. In other words, as the range of the pulse width Wj, there can be cited, for example, (AP/3)<Wj.

It should be noted that the AP described above corresponds to a period (1AP=(characteristic vibration period of the ink 9)/2) half as large as the characteristic vibration period of the ink 9 in the ejection channel C1e, C2e. Further, when the pulse width of a certain pulse is set to the AP, the ejection speed (the ejection efficiency) of the ink 9 is maximized when ejecting (making one droplet ejection of) the ink 9 as much as one normal droplet. Further, the AP is arranged to be defined by, for example, the shape of the ejection channels C1e, C2e or a physical property (the specific gravity or the like) of the ink 9.

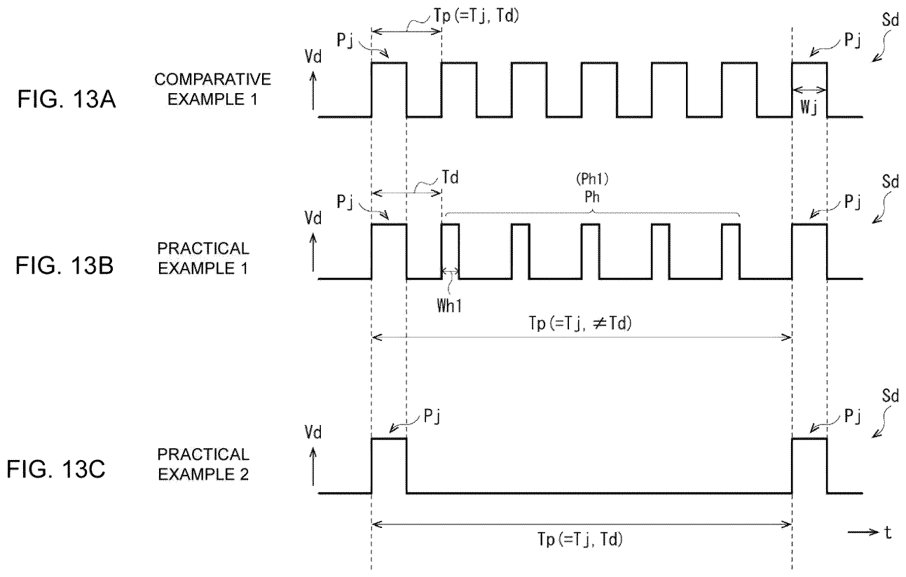

It should be noted that the details of such an ejection pulse Pj and such a heat generation pulse Ph will be described later (FIG. 13 to FIG. 19).

### [Operations and Functions/Advantages]

### (A. Basic Operation of Printer 1)

In the printer 1, a recording operation (the printing operation) of images, characters, and so on to the recording paper P is performed in the following manner. It should be noted that as an initial state, it is assumed that the four types of ink tanks 3 (3Y, 3M, 3C, and 3K) shown in FIG. 1 are sufficiently filled with the ink 9 of the corresponding colors (the four colors), respectively. Further, there is achieved the state in which the inkjet heads 4 are filled with the ink 9 in the ink tanks 3 via the ink supply tubes 50, respectively.

In such an initial state, when making the printer 1 operate, the grit rollers 21 in the conveying mechanisms 2a, 2b each rotate to thereby convey the recording paper P along the conveyance direction d (the X-axis direction) between the grit rollers 21 and the pinch rollers 22. Further, at the same time as such a conveyance operation, the drive motor 633 in the drive mechanism 63 rotates each of the pulleys 631a, 631b to thereby make the endless belt 632 operate. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4K) to thereby perform the recording operation of images, characters, and so on to the recording paper P.

### (B. Detailed Operation in Inkjet Head 4)

Subsequently, the detailed operation in the inkjet head 4 will be described.

First, in this inkjet head 4, the jet operation of the ink 9 using a shear mode is performed in the following manner. In other words, by the drive unit 49 performing the ejection drive using the drive signal Sd described above on the actuator plate 42, the ink 9 filling the ejection channels C1e, C2e is ejected from the nozzle holes Hn.

When performing such ejection drive, the drive unit 49 applies the drive voltages Vd (the drive signals Sd) to the drive electrodes Ed (the common electrodes Edc and the individual electrodes Eda) located inside the actuator plate 42. Specifically, the drive unit 49 applies the drive voltage Vd to the drive electrodes Ed (the common electrodes Edc and the individual electrodes Eda) disposed on the pair of drive walls Wd partitioning the ejection channels C1e, C2e. Thus, the pair of drive walls Wd each deform so as to protrude toward the dummy channel C1d, C2d adjacent to the ejection channel C1e, C2e.

Here, as described above, in the actuator plate 42, the polarization direction is set to the one direction, and at the same time, the drive electrodes Ed are not formed beyond the intermediate position in the depth direction on the inner side surfaces in the drive walls Wd. Therefore, application of the drive voltage Vd using the drive unit 49 results in a flexion deformation of the drive wall Wd having a V shape centered on the intermediate position in the depth direction in the drive wall Wd. Further, due to such a flexion deformation of the drive wall Wd, the ejection channel C1e, C2e deforms as if the ejection channel C1e, C2e bulges (see the expansion directions d11 shown in FIG. 7).

Incidentally, in the case in which the configuration of the actuator plate 42 is not the cantilever type but is the chevron type described above, the drive wall Wd makes the flexion deformation to have the V shape in the following manner. Specifically, in the case of the chevron type, the polarization direction of the actuator plate 42 differs along the thickness direction (the two piezoelectric substrates described above are stacked on one another), and at the same time, the drive electrodes Ed are formed in the entire length in the depth direction on the inner side surface in each of the drive walls Wd. Therefore, application of the drive voltage Vd using the drive unit 49 described above results in a flexion deformation of the drive wall Wd having a V shape centered on the intermediate position in the depth direction in the drive wall Wd. As a result, also in this case, due to such a flexion deformation of the drive wall Wd, the ejection channel C1e, C2e deforms as if the ejection channel C1e, C2e bulges (see the expansion directions d11 shown in FIG. 7).

As described above, due to the flexion deformation caused by a piezoelectric thickness-shear effect in the pair of drive walls Wd, the volume of the ejection channel C1e, C2e increases. Further, the increase in the capacity of the ejection channel C1e, C2e results in that the ink 9 retained in the supply-side common flow channel Rin1, Rin2 is induced into the ejection channel C1e, C2e via the supply slit Sin1, Sin2 (see, e.g., the dotted arrow in FIG. 6).

Subsequently, the ink 9 having been induced into the ejection channel C1e, C2e in such a manner turns to a pressure wave to propagate to the inside of the ejection channel C1e, C2e. Then, the drive voltage Vd to be applied to the drive electrodes Ed becomes 0 (zero) V at the timing at which the pressure wave has reached the nozzle hole Hn of the nozzle plate 41 (or timing in the vicinity of that timing). Thus, the drive walls Wd are restored from the state of the flexion deformation described above, and as a result, the capacity of the ejection channel C1e, C2e having once increased is restored again (see, e.g., the contraction directions db shown in FIG. 7).

In the process in which the volume of the ejection channel C1e, C2e is restored in such a manner, the internal pressure of the ejection channel C1e, C2e increases, and the ink 9 in the ejection channel C1e, C2e is pressurized. As a result, the ink 9 shaped like a droplet is ejected toward the outside (toward the recording paper P or the like) through the nozzle hole Hn (see FIG. 2, and FIG. 5 to FIG. 7). The jet operation (the ejection operation) of the ink 9 in the inkjet head 4 is performed in such a manner, and as a result, the recording operation (the printing operation) of images, characters, and so on to the recording paper P is performed.

It should be noted that some of the ink 9 which fills the inside of the ejection channels C1e, C2e is recovered into the recovery-side common flow channels Rout1, Rout2 via the recovery slits Sout1, Sout2, respectively (see, e.g., the dotted arrow in FIG. 6). Further, the ink 9 having been recovered into these recovery-side common flow channels Rout1, Rout2 is returned to the inside of the ink tank 3 from the inside of the inkjet head 4 via the ink supply tube 50. In such a manner, the circulation operation of the ink 9 is performed as a result.

### (C. Regarding Heat Generation Amount Control Using Heat Generation Pulse Ph)

Subsequently, heat generation amount control (control of the heat generation amount Δh generated when the drive unit 49 drives the actuator plate 42 and so on) using the heat generation pulse Ph described above in the present embodiment will be described in detail.

### (C-1. Related Art Method)

First, in general in a related-art inkjet head, when using ink high in viscosity, around 20 (mPa·s) is an upper limit of the viscosity with which the ink can stably be ejected. Further, when using ink having higher viscosity than above, a mechanism which heats the ink tank or the inkjet heat itself to achieve a reduction in viscosity of the ink was required. Therefore, in the related-art method, there arose problems such as complication of the configuration, an increase in apparatus price, and an increase in power consumption, and it was difficult to improve the ejection stability of the ink. Further, although it became possible to eject ink having high viscosity exceeding 20 (mPa·s) described above by, for example, increasing the displacement in the actuator plate, since the actuator plate and so on were affected by the heat generation which occurred when the actuator plate and so on were driven, there also arose a problem that the ejection speed of the ink fluctuated in accordance with the drive frequency or an ejection rate.

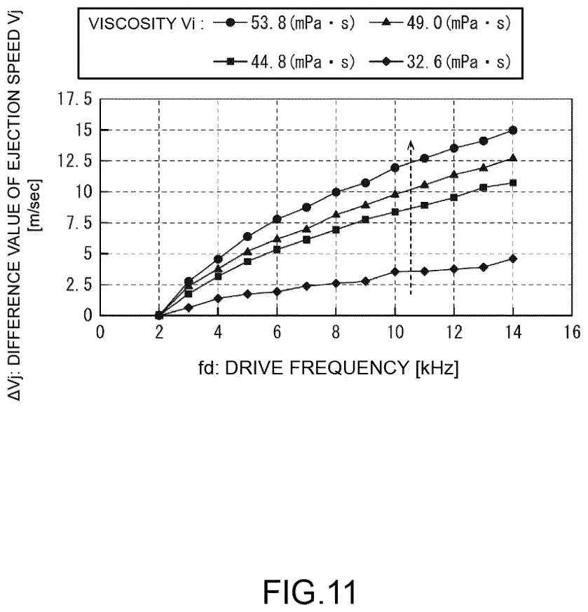

Here, FIG. 11 shows an example (when making the drive voltage Vd constant) of a correspondence relationship between a drive frequency fd when performing the ejection drive and an ejection speed Vj of the ink 9 in accordance with a viscosity Vi of the ink in a related-art general inkjet head. It should be noted that the vertical axis in FIG. 11 represents a difference value ΔVj of the ejection speed Vj with reference to the ejection speed Vj at the drive frequency fd=2 (kHz). Further, the ejection speed Vj in FIG. 11 is a value representing the ejection speed Vj by converting, by calculation, what is obtained by setting the drive voltage Vd necessary to obtain the speed which is assumed as constant to the vertical axis. In this example shown in FIG. 11, it is understood that when performing the ejection drive, the temperature of the ink rises due to the heat generation in the actuator plate and so on to thereby decrease the viscosity of the ink, and therefore, the ejection speed Vj increases as the drive frequency fd increases at the same drive voltage Vd, and thus, the ejection speed Vj fluctuates. Further, it is understood that at the same drive frequency fd, the ejection speed Vj increases as the viscosity Vi increases, and thus the ejection speed Vj fluctuates (see the dotted arrow in FIG. 11).

From these facts, it is desired to propose a method which makes it possible to make it easy to suppress the variation in the ejection characteristics (the variation in the ejection speed Vj and so on) of the ink 9 to thereby easily improve the ejection stability (uniformity, compatibility) of the ink 9 even when jetting the ink 9 having high viscosity.

### (C-2. Method in Present Embodiment)

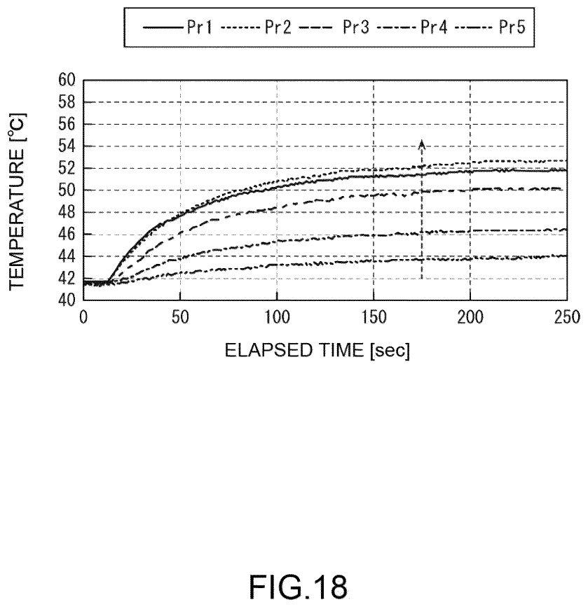

Therefore, in the inkjet head 4 according to the present embodiment, it is arranged that the heat generation pulse Ph for controlling the heat generation amount Δh which is generated when the drive unit 49 performs the drive described above is included in addition to the ejection pulse Pj as the plurality of pulses in the drive signal Sd. Further, by including such a heat generation pulse Ph in the drive signal Sd, it is arranged that the viscosity of the ink 9 is decreased to the viscosity with which the ink 9 can be ejected (preliminary heating is performed) by making the actuator plate 42 itself generate heat to heat the ink 9 in the ejection channels C1e, C2e. It should be noted that since it takes some time for the temperature of the ink 9 to rise and then converge, it is arranged that the viscosity of the ink 9 is decreased to the viscosity with which the ink 9 is easily ejected by driving the actuator plate 42 and so on to perform the preliminary heating described above although the details will be described later (see FIG. 18).

Further, as a control method of the heat generation amount Δh using such a heat generation pulse Ph, it is arranged that the heat generation amount Δh is controlled in accordance with a pulse count Np of the heat generation pulses Ph included in the print period Tp as an example in the present embodiment. It should be noted that as another method, there can be cited, for example, the drive voltage Vd and the pulse width Wh of the heat generation pulse Ph.

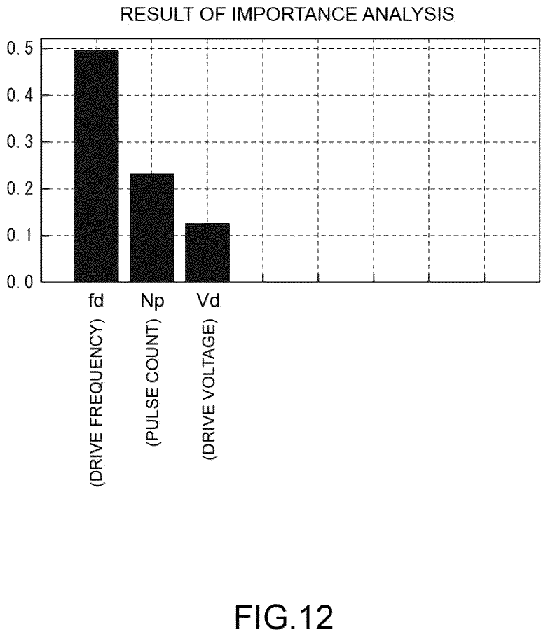

FIG. 12 is a diagram showing an example of a result of an importance analysis of a variety of parameters making a contribution to the temperature of the actuator plate 42 and so on. In the result of the importance analysis shown in FIG. 12, it is understood that the contribution ratio of the drive frequency fd is the highest, and further, the contribution ratio is higher in the order of the pulse count Np of the heat generation pulse Ph and the drive voltage Vd. It should be noted that it is understood that since the degree of freedom as the head performance of the inkjet head 4 decreases when performing the heat generation amount control using the drive frequency fd, it is more meaningful to perform the heat generation amount control using the pulse count Np of the heat generation pulse Ph. In other words, it can be said that it is easier to control the heat generation amount Δh using the pulse count Np compared to when using the pulse width Wh and so on.

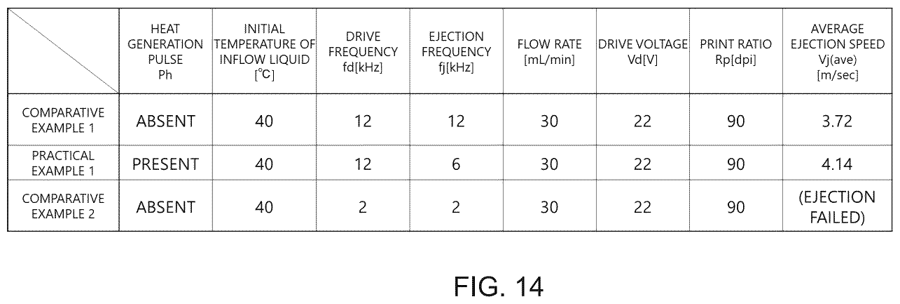

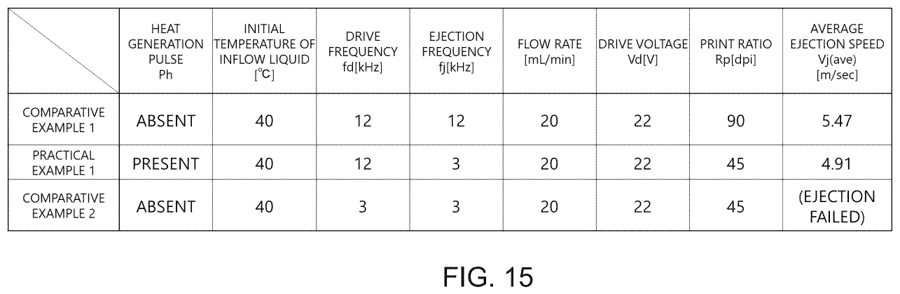

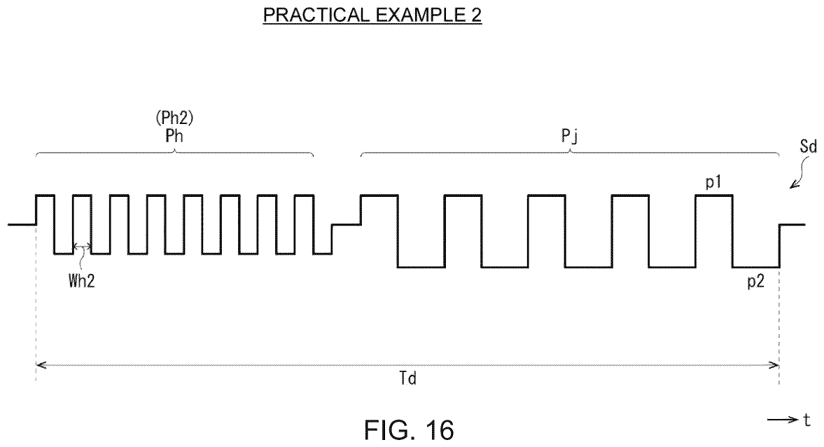

Here, FIGS. 13A to 13C are timing charts schematically showing an example of a variety of pulses in the drive signal Sd related to Comparative Examples 1, 2 and Practical Example 1 of the present embodiment. Specifically, FIGS. 13A to 13C respectively show the drive signals Sd related to Comparative Example 1, Practical Example 1, and Comparative Example 2. Further, FIG. 14 and FIG. 15 are each a diagram showing an example of average ejection speed Vj(ave) of the ink 9 in a variety of conditions related to Comparative Examples 1, 2 and Practical Example 1 in the form of a table. Further, FIG. 16 is a timing chart schematically showing an example of a variety of pulses in the drive signal Sd related to Practical Example 2 of the present embodiment. It should be noted that in all of FIGS. 13A to 13C and FIG. 16, the vertical axis represents the voltage value of the drive voltage Vd, and the horizontal axis represents time t. Further, in the example of the ejection pulse Pj shown in FIGS. 13A to 13C, the plurality of pulses (the pulses p1, p2 described above) is illustrated in a lump for the sake of convenience.

First, in Comparative Example 1 shown in FIG. 13A, only the ejection pulses Pj defining the print period Tp (=an ejection period Tj, a drive period Td) are disposed in a row along the time axis. Further, also in Comparative Example 2 shown in FIG. 13C, only the ejection pulses Pj defining the print period Tp (=the ejection period Tj, the drive period Td) are disposed in a row along the time axis. However, the print period Tp (e.g., 12 [kHz]) in Comparative Example 1 takes a value several times (six times, in this example) as large as the print period Tp (e.g., 2 [kHz]) in Comparative Example 2.

In contrast, in Practical Example 1 shown in FIG. 13B, one heat generation pulse Ph1 or a plurality of heat generation pulses Ph1 (five heat generation pulses Ph1 in this example) as the heat generation pulse Ph is disposed between the ejection pulses Pj defining the print period Tp (=the ejection period Tj, ≠the drive period Td). Incidentally, in Practical Example 1, it results in that the plurality of drive periods Td defined by the ejection pulse Pj and the heat generation pulses Ph1 is disposed in the print period Tp. Further, in Practical Example 2 shown in FIG. 16, one heat generation pulse Ph2 or a plurality of heat generation pulses Ph2 (the plurality of heat generation pulses Ph2 in this example) is further disposed in at least one drive period Td out of the plurality of drive periods Td in the drive signal Sd. It should be noted that the pulse widths Wh1, Wh2 of such heat generation pulses Ph1, Ph2 are each made substantially the same range (e.g., (AP/6)≤Wh1≤(AP/3), (AP/6)≤Wh2≤(AP/3)) as that of the pulse width Wh described above.

Further, in one example of the average ejection speed Vj(ave) of the ink 9 in the variety of conditions shown in FIG. 14, first, in Comparative Example 2, the ink 9 high in viscosity cannot be ejected due to the fact that an ejection frequency fj is low and the heat generation amount Δh is small (the same applies to Comparative Example 2 in FIG. 15 described below). In contrast, in Practical Example 1, by disposing the heat generation pulse Ph1, it is possible to keep the heat generation amount Δh equivalent to that in Comparative Example 1 even when the ejection frequency fj changes from the case of Comparative Example 1, and thus, substantially the same average ejection speed Vj(ave) as the case of Comparative Example 1 is exhibited.

Further, in one example of the average ejection speed Vj(ave) of the ink 9 in a variety of conditions shown in FIG. 15, the following is arranged. That is, in Practical Example 1 shown in FIG. 15, when a print ratio Rp along the direction (the X-axis direction) of the nozzle arrays 411, 412 described above is not 100%, the heat generation pulse Ph is included even in the drive signal Sd corresponding to the nozzle hole Hn corresponding to the non-ejection period. In other words, it is arranged that the heat generation pulse Ph is included even in the drive signal Sd corresponding to the nozzle hole Hn corresponding to the non-ejection period corresponding to the print content to the recording target medium (the recording paper P). Thus, it is arranged that the equivalent average ejection speed Vj(ave) is maintained even when the print ratio Rp changes between Practical Example 1 and Comparative Example 1. Further, it is arranged that the equivalent average ejection speed Vj(ave) is maintained even when the ejection frequency fj changes between Practical Example 1 and Comparative Example 1. As described above, in Practical Example 1, the heat generation amount Δh by the heat generation pulse Ph is controlled so that the fluctuation in the ejection speed Vj of the ink 9 can be suppressed even when at least one of the ejection frequency fj and the print ratio Rp changes.

It should be noted that the heat generation pulse Ph1 described above corresponds to a specific example of a “first heat generation pulse” in the present disclosure. Further, the heat generation pulse Ph2 described above corresponds to a specific example of a “second heat generation pulse” in the present disclosure.

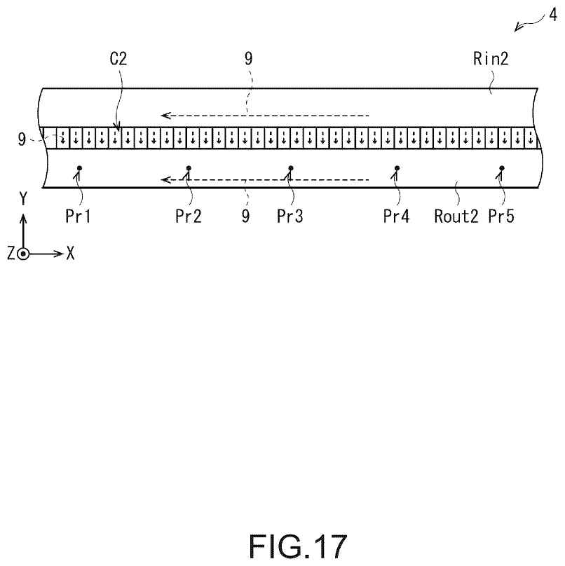

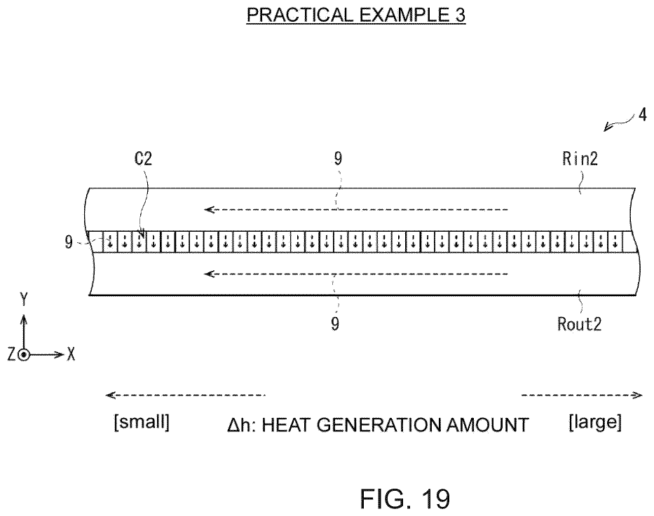

Further, FIG. 17 is a plan view (an X-Y plan view) schematically showing an example of temperature measurement places in the common flow channels (the supply-side common flow channel Rin2 and the recovery-side common flow channel Rout2 in the example shown in FIG. 17) shown in FIG. 3 and so on. FIG. 18 is a diagram showing an example of a temporal change of the temperature at temperature measurement places Pr1 to Pr5 shown in FIG. 17. FIG. 19 is a plan view (an X-Y plan view) schematically showing an example of a method of the heat generation amount control related to Practical Example 3 of the present embodiment.

First, as shown in, for example, FIG. 18, in the plurality of channels C1, C2 (the channel C2 in the example of FIG. 17) along the common flow channel, the temperature of the ink 9 tends to rise as the time in which the ink 9 has contact with the actuator plate 42 and so on in the direction (the X-axis direction) in which the ink 9 flows becomes longer. In other words, in the example of FIG. 18, the temperature of the ink 9 gradually rises (see the dotted arrow shown in FIG. 18) in the order of the temperature measurement places Pr5, Pr4, Pr3, Pr2, and Pr1 (toward the downstream from the upstream of the ink 9 in the common flow channel).

Therefore, in Practical Example 3 shown in FIG. 19, for example, the heat generation amount Δh is controlled by the heat generation pulse Ph so that a gradient in the thermal distribution among the plurality of channels C2 along such a common flow channel (a temperature gradient of the temperature rising from the upstream toward the downstream) decreases. Specifically, as shown in, for example, FIG. 19, the control of the heat generation amount Δh (e.g., the control by the pulse count Np of the heat generation pulse Ph described above) is performed so that the heat generation amount Δh gradually increases from the downstream of the ink 9 in the common flow channel toward the upstream. Thus, the non-uniformity of the temperature of the ink 9 is suppressed among the plurality of channels C2 along the common flow channel, and the non-uniformity of the viscosity of the ink 9 is also suppressed, and as a result, the ejection stability of the ink 9 is achieved.

Incidentally, in the inkjet head 4 of the circulation type as in the present embodiment, there is a tendency that the thermal saturation becomes difficult to occur in the actuator plate 42 and so on since the actuator plate 42 and so on are cooled by the ink 9, and the temperature gradient in the direction of the nozzle arrays 411, 412 described above increases when the flow rate of the ink 9 rises (when the flow rate is high). In this case, since the temperature of the ink 9 becomes difficult to rise, and the viscosity of the ink 9 also becomes difficult to decrease, there is a problem that it is necessary to raise the drive voltage Vd. Therefore, in the inkjet head 4 of the circulation type, by setting the flow rate of the ink 9 to be circulated to be, for example, lower than 50 (mL/min), it becomes possible to achieve the ejection stability of the ink 9, and at the same time, achieve the reduction in the drive voltage Vd. Further, for example, it can be said that it is desirable to set the flow rate of the ink 9 flowing per channel C1, C2 to be, for example, lower than 0.2 (mL/min) in average, and it is more desirable to set the flow rate to be around 0.13 (mL/min).

### (D. Functions/Advantages)

In such a manner, in the present embodiment, since it is arranged that the ejection pulse Pj and the heat generation pulse Ph are included in the print period Tp in the drive signal Sd, the following is achieved. That is, since the heat generation amount Δh generated when the actuator plate 42 and so on are driven is controlled by the heat generation pulses Ph, it becomes easy to control such a heat generation amount Δh. Therefore, as described above, for example, even when jetting the ink 9 having high viscosity, it becomes easy to suppress the variation in the ejection characteristics (the ejection speed Vj and so on) of the ink 9. As a result, in the present embodiment, it becomes possible to easily improve the ejection stability of the ink 9.

Further, in the present embodiment, for example, by providing, using the heat generation pulses Ph, the heat generation amount Δh which achieves an equivalent temperature to the temperature on which the temperature is converged when performing the continuous drive by the ejection pulses Pj, it becomes possible to further improve the ejection stability of the ink 9. Further, in the present embodiment, by always using the heat generation pulses Ph at the highest ejection frequency fj in the ejection request, and using the ejection pulse Pj when the ejection is requested, it becomes possible to achieve the stabilization of the ejection speed Vj. In addition, in the present embodiment, it becomes possible to achieve stable ejection of the ink 9 having the high viscosity exceeding, for example, 20 (mPa·s). It should be noted that it was confirmed that the stable ejection was possible even when using the ink 9 having the high viscosity up to about 127 (mPa·s) as an example within a measurable range.

Further, in the present embodiment, when it is arranged that the heat generation pulse Ph2 is further disposed in at least one drive period Td out of the plurality of drive periods Td in addition to the fact that the heat generation pulse Ph1 is disposed between the ejection pulses Pj which define the print period Tp, the following is achieved. That is, for example, it becomes easy to perform the control (fine adjustment or the like) of the heat generation amount Δh in the drive signals Sd corresponding respectively to the nozzle holes Hn, and therefore, it becomes possible to further improve the ejection stability of the ink 9.

Further, in the present embodiment, since it is arranged that the heat generation amount Δh is controlled in accordance with the pulse count Np of the heat generation pulses Ph included in the print period Tp, the following is achieved. That is, since it becomes easy to control the heat generation amount Δh compared to the case of the heat generation amount control using, for example, other parameters (the drive voltage Vd, the pulse widths Wh1, Wh2, the drive frequency fd, and so on) described above, it becomes possible to further improve the ejection stability of the ink 9.

In addition, in the present embodiment, when the heat generation amount Δh by the heat generation pulse Ph is controlled so that the fluctuation in the ejection speed Vj of the ink 9 can be suppressed when at least one of the ejection frequency fj and the print ratio Rp described above changes, the following is achieved. In other words, even when such parameters change, the fluctuation of the ejection speed Vj can be suppressed, and therefore, it becomes possible to further improve the ejection stability of the ink 9.

Further, in the present embodiment, when the heat generation amount Δh by the heat generation pulses Ph is controlled so that the gradient (the temperature gradient) in the thermal distribution between the plurality of channels C1, C2 along the common flow channels (the supply-side common flow channels Rin1, Rin2 and the recovery-side common flow channels Rout1, Rout2) decreases, the following is achieved. That is, since the heat generation amount control is performed so that the heat gradient between such a plurality of channels C1, C2 decreases, it results in that the variation in the ejection characteristics (the ejection speed Vj and so on) of the ink 9 between the plurality of channels C1, C2 is further suppressed. As a result, it becomes possible to further improve the ejection stability of the ink 9.

Further, in the present embodiment, since it is arranged that the heat generation amount control using the heat generation pulses Ph described above is performed in the inkjet head 4 of the circulation type described above, the following is achieved. That is, first, in the inkjet head of the non-circulation type (the system in which the ink 9 is not circulated between the ink tank 3 and the inkjet head 4), in general, there is a problem that the heat is confined in the inkjet head. Specifically, the heat discharge is performed due to the ejection of the ink 9 in the ejection channel on the one hand, but such heat discharge is not performed in the non-ejection channel on the other hand, and therefore, it results in that a difference in heat accumulation occurs between the channels. In contrast, in the inkjet head of the circulation type, since the ink 9 is circulated, such a difference in heat accumulation between the channels is prevented, and therefore, it becomes possible to further improve the ejection stability of the ink 9.

### <2. Modified Examples>

The present disclosure is described hereinabove citing the embodiment and the practical examples, but the present disclosure is not limited to the embodiment and so on, and a variety of modifications can be adopted.

For example, in the embodiment and so on described above, the description is presented specifically citing the configuration examples (the shapes, the arrangements, the number and so on) of each of the members in the printer and the inkjet head, but those described in the above embodiment and so on are not limitations, and it is possible to adopt other shapes, arrangements, numbers and so on. Further, the values or the ranges, the magnitude relation and so on of a variety of parameters described in the above embodiment and so on are not limited to those described in the above embodiment and so on, but can also be other values or ranges, other magnitude relation and so on.

Specifically, for example, although in the embodiment and so on described above, the examples of the types and the number of the pulses included in the drive signal Sd, the levels of the drive voltage Vd and a variety of frequencies, the setting value of the pulse width, and so on are specifically cited and described, those explained in the embodiment and so on described above are not limitations.

Further, a variety of types of structures can be adopted as the structure of the inkjet head. Specifically, for example, in the embodiment and so on described above, the description is presented citing as an example a so-called side-shoot type inkjet head for ejecting the ink 9 from a central part in the extending direction of each of the ejection channels in the actuator plate. However, this example is not a limitation, and for example, it is possible to adopt a so-called edge-shoot type inkjet head for ejecting the ink 9 along the extending direction of each of the ejection channels. Further, in the embodiment and so on described above, the description is presented citing the circulation type inkjet head for using the ink 9 while circulating the ink 9 between the ink tank 3 and the inkjet head 4 as an example, but the example is not a limitation. Specifically, for example, it is also possible to apply the present disclosure to a non-circulation type inkjet head which does not circulate the ink 9 between the ink tank 3 and the inkjet head 4.

Further, the type of the printer is not limited to the type described in the embodiments and so on described above, and it is possible to apply a variety of types such as an MEMS (Micro Electro-Mechanical Systems) type.

In addition, although in the embodiment and so on described above, the method of the heat generation amount control using the heat generation pulses is described citing a specific example, the methods cited in the embodiment and so on described above are not a limitation, and it is possible to use other methods. Further, for example, it is possible to arrange that two or more of the methods cited in the embodiment and so on are used in combination as appropriate.

Further, the series of processing described in the above embodiments and so on can be arranged to be performed by hardware (a circuit), or can also be arranged to be performed by software (a program). When arranging that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the embodiment and so on described above, the description is presented citing the printer 1 (the inkjet printer) as a specific example of the “liquid jet recording apparatus” in the present disclosure, but this example is not a limitation, and it is also possible to apply the present disclosure to other apparatuses than the inkjet printer. In other words, it is also possible to arrange that the “liquid jet head” (the inkjet head) of the present disclosure is applied to other apparatuses than the inkjet printer. Specifically, it is also possible to arrange that the “liquid jet head” of the present disclosure is applied to an apparatus such as a facsimile, an on-demand printer, a shaped article of 3D printing, application of an adhesive, and an apparatus for forming a biomaterial using ejection of biological polymer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.

What is claimed is:

1. A liquid jet head comprising:
a jet unit including a plurality of nozzles configured to jet a liquid, and a plurality of pressure chambers communicated individually with the nozzles, and each filled with the liquid; and
a drive unit configured to drive the jet unit based on a drive signal having a plurality of pulses in a predetermined print period to thereby jet the liquid which fills an inside of the pressure chamber from the nozzle, wherein
the plurality of pulses in the drive signal includes
one ejection pulse or a plurality of ejection pulses having a pulse width in a range in which the liquid is ejected from the nozzle, and
one heat generation pulse or a plurality of heat generation pulses which has a pulse width in a range in which the liquid is not ejected from the nozzle, and which is configured to control a heat generation amount generated when the jet unit is driven.

2. The liquid jet head according to claim 1, wherein
one first heat generation pulse or a plurality of first heat generation pulses as the heat generation pulse is disposed between the ejection pulses configured to define the print period.

3. The liquid jet head according to claim 2, wherein
the print period includes a plurality of drive periods defined by the ejection pulse and the first heat generation pulse, and
one second heat generation pulse or a plurality of second heat generation pulses as the heat generation pulse is further disposed in at least one of the plurality of drive periods.

4. The liquid jet head according to claim 1, wherein
the heat generation amount is controlled in accordance with a pulse count of the heat generation pulses included in the print period.

5. The liquid jet head according to claim 1, wherein
the drive signal corresponding to the nozzle corresponding to a non-jet period corresponding to a print content to a recording target medium is set to include the heat generation pulse.

6. The liquid jet head according to claim 1, wherein
when at least one of an ejection frequency when the liquid is ejected from the nozzle and a print ratio to a recording target medium changes,
the heat generation amount by the heat generation pulse is controlled so that a fluctuation of ejection speed of the liquid is suppressed.

7. The liquid jet head according to claim 1, wherein
the jet unit further includes a common flow channel of the liquid which extends along an arrangement direction of the plurality of pressure chambers, and which communicates with the plurality of pressure chambers, and
the heat generation amount by the heat generation pulse is controlled so that a gradient in a thermal distribution among the plurality of pressure chambers along the common flow channel decreases.

8. The liquid jet head according to claim 7, wherein
the heat generation amount by the heat generation pulse is controlled so that the heat generation amount gradually increases from a downstream of the liquid in the common flow channel toward an upstream.

9. The liquid jet head according to claim 7, wherein
the jet unit further includes
a liquid supply flow channel configured to supply the pressure chamber with the liquid, and
a liquid recovery flow channel configured to recover the liquid from the pressure chamber.

10. A liquid jet recording apparatus comprising:
the liquid jet head according to claim 1.
